(19) United States
(12) Patent Application Publication
(10) Pub. No.: US 2024/0325234 A1
(43) Pub. Date: Oct. 3, 2024

(54) PHYSICAL REHABILITATION THERAPY DEVICE

(71) Applicant: RYAN MEEHAN, Charles Town, WV (US)

(72) Inventor: RYAN MEEHAN, Charles Town, MD (US)

(73) Assignee: RYAN MEEHAN, Charles Town, WV (US)

(21) Appl. No.: 18/128,944

(22) Filed: Mar. 30, 2023

(51) Int. Cl. A61H 7/00

(52) U.S. Cl. CPC A61H 7/004; A61H 2201/0123; A61H 2201/0126; A61H 2201/10; A61H 2201/1642; A61H 2203/0406

(57) ABSTRACT

An adjustable physical therapy device that includes a massaging frame and massaging points. The massaging frame includes vertical support arms and horizontal support arms. The vertical support arms are positioned parallel to each other. The horizontal support arms are slidably coupled to the vertical support arms. The massaging points are each slidably coupled to and protrude from one of the horizontal support arms in a manner to press against a user when the user is positioned against the massaging frame. At least one of the massaging points includes a magnet positioned on an end of the massaging point. At least one of the massaging points includes an electrified end configured to provide pulsed electromagnetic field therapy. The vertical support arms each include a wheel. The wheel is rotatably coupled to the vertical support arm opposite the horizontal support arms.

### TECHNICAL FIELD

The present invention relates generally to physical therapy and specifically to physical rehabilitation therapy device.

### BACKGROUND

Following an injury (e.g., sports related or due to an automobile accident), the injured person often has to perform physical therapy to regain functional control of their lower extremities. One goal of physical therapy is typically to achieve proper biomechanics during normal everyday functional movements. Faulty biomechanics in the lower extremity, due to various muscular impairments, is often linked to injury and poor prognosis. Various verbal and tactile cues are made in an attempt to correct faulty biomechanical movement of a person's limbs during functional movement. In addition to postural cues, general strengthening of muscles thought to aid in desired motion, or control faulty movement pattern, is also included.

If a person does not gain proper control of their functional movements, they may suffer setbacks or be at increased risk of injury during functional activity. After some time, insurance companies may stop paying for the physical therapist and/or the patient wants to continue therapy in the convenience of his or her own home. Typically, if the patient is unable to properly perform the therapy without the assistance of a trained physical therapist, the patient may suffer setbacks. There exists a need in the art for an unassisted physical rehabilitation therapy device.

### BRIEF DESCRIPTION OF THE DRAWINGS

FIG. 1 depicts a front view of physical therapy device, in accordance with some embodiments.

FIG. 2 depicts a side view of the adjustable physical therapy device, in accordance with yet still other embodiments.

FIG. 3 depicts an exploded side view of an affixing fastener, in accordance with certain embodiments.

FIG. 4 depicts an exploded side view of a massaging point, in accordance with yet still other embodiments.

FIG. 5 depicts a front view of a user positioned on the massaging frame, in accordance with other embodiments.

FIG. 6 depicts a side view of a shoulder attachment of the massaging frame, in accordance with certain embodiments.

FIG. 7 depicts an exploded view of an adjustable handle, in accordance with yet still other embodiments.

FIG. 8 depicts a side view of the adjustable handle, in accordance with some embodiments.

FIG. 9 depicts a front view of an adjustable physical therapy device in a “folded state,” in accordance with some embodiments.

FIG. 10 depicts a side view of the adjustable back therapy device in an “unfolded state,” in accordance with other embodiments.

### DETAILED DESCRIPTION

The descriptions of the various embodiments of the instant disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Certain terminology may be employed in the following description for convenience rather than for any limiting purpose. For example, the terms “forward” and “rearward,” “front” and “rear,” “right” and “left,” “upper” and “lower,” and “top” and “bottom” designate directions in the drawings to which reference is made, with the terms “inward,” “inner,” “interior,” or “inboard” and “outward,” “outer,” “exterior,” or “outboard” referring, respectively, to directions toward and away from the center of the referenced element, the terms “radial” or “horizontal” and “axial” or “vertical” referring, respectively, to directions or planes which are perpendicular, in the case of radial or horizontal, or parallel, in the case of axial or vertical, to the longitudinal central axis of the referenced element, the terms “proximate” and “distal” referring, respectively, to positions or locations that are close or away from a point of reference, and the terms “downstream” and “upstream” referring, respectively, to directions in and opposite that of fluid flow. Terminology of similar import other than the words specifically mentioned above likewise is to be considered as being used for purposes of convenience rather than in any limiting sense.

In the figures, elements having an alphanumeric designation may be referenced herein collectively or in the alternative, as will be apparent from context, by the numeric portion of the designation only. Further, the constituent parts of various elements in the figures may be designated with separate reference numerals which shall be understood to refer to that constituent part of the element and not the element as a whole. General references, along with references to spaces, surfaces, dimensions, and extents, may be designated with arrows.

Angles may be designated as “included” as measured relative to surfaces or axes of an element and as defining a space bounded internally within such element therebetween, or otherwise without such designation as being measured relative to surfaces or axes of an element and as defining a space bounded externally by or outside of such element therebetween. Generally, the measures of the angles stated are as determined relative to a common axis, which axis may be transposed in the figures for purposes of convenience in projecting the vertex of an angle defined between the axis and a surface which otherwise does not extend to the axis. The term “axis” may refer to a line or to a transverse plane through such line as will be apparent from context.

Following an injury (e.g., sports related or due to an automobile accident), the injured person often has to perform physical therapy to regain functional control of their lower extremities. One goal of physical therapy may be achieving proper biomechanics during normal everyday functional movements. Faulty biomechanics in the lower extremity, due to various muscular impairments, has in the past been linked to injury and poor prognosis. Various verbal and tactile cues are made in attempt to correct faulty biomechanical movement of a person's limbs during functional movement. In addition to postural cues, general strengthening of muscles thought to aid in desired motion, or control faulty movement pattern, is also included.

If a person does not gain proper control of their functional movements, the person may suffer setbacks or be at increased risk of injury during functional activity. After some time, the insurance may stop paying for the physical therapist and/or the patient wants to continue therapy in the convenience of his or her own home. If the patient is unable to properly perform the therapy without the assistance of a trained physical therapist, the patient may suffer setbacks. There exists a need in the art for an unassisted physical rehabilitation therapy device.

Embodiments of the instant disclosure seek to provide an adjustable physical therapy device that users operate in an unassisted manner. Other aspects of the instant disclosure seek to provide an adjustable physical therapy device that is width and length adjustable to accommodate a variety of user body parts (e.g., back, legs, arms, neck, torso, feet, etc.). Additional aspects of the instant disclosure seek to provide an adjustable physical therapy device that is width and length adjustable to accommodate a variety of user heights. Some aspects of the instant disclosure seek to provide an adjustable physical therapy device that that provides pulsed electric current stimulation. Yet still other aspects of the instant disclosure seek to provide an adjustable physical therapy device that provides magnetic field stimulation to address pain and/or discomfort. Some embodiments of the instant disclosure seek to provide an adjustable physical therapy device that can be utilized when positioned horizontally, vertically, or at an angle to address the user's particular physical therapeutic needs.

The adjustable back therapy device 100 is a modular device configured to allow users to address physical discomfort pain issues in a self-assisted manner regardless of the height or the breadth of their shoulders. One or more components of the adjustable physical therapy device 100 are preferably metallic structures (e.g., galvanized steel, aluminum, brass, etc.), but they can also be made using high tensile strength polymeric materials (e.g., polyethylene terephthalate (PET), Nylon, polyphenylene sulfide (PPS), polyetheretherketone (PEEK), polyetherimide (PEI), polyamideimide (PAI), as well as other polymers that have a tensile strength of at least 10,000 psi).

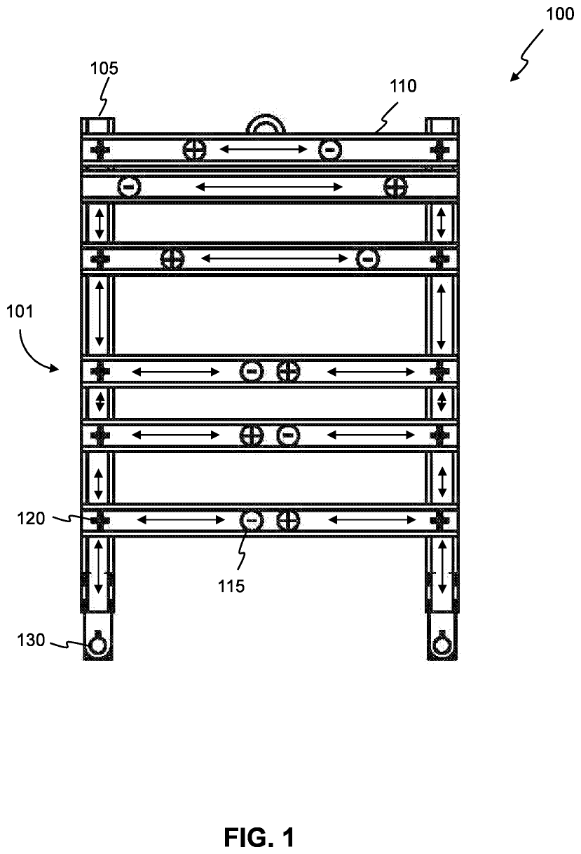

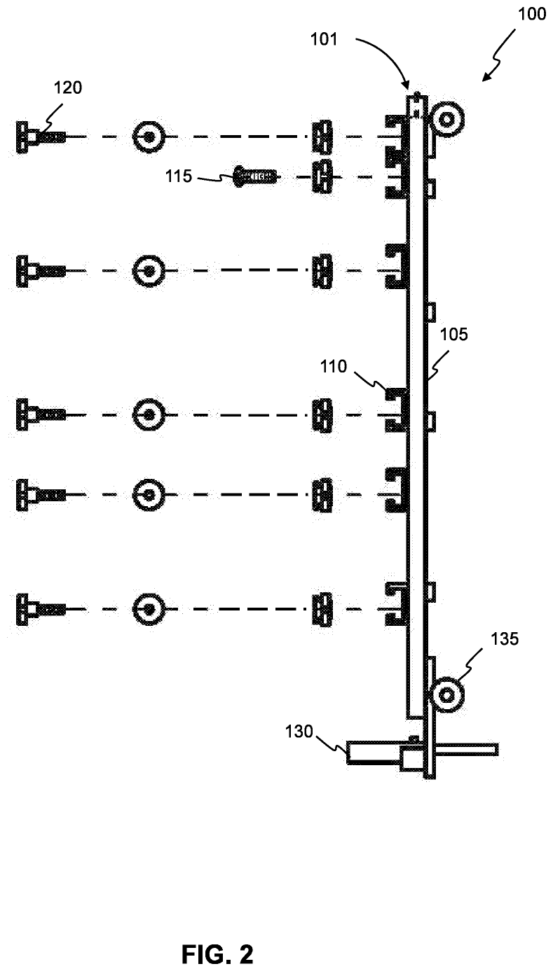

Turning now to the Figures. FIG. 1 depicts a front view of physical therapy device, generally 100, in accordance with some embodiments. Physical therapy devices that are known in the art to address muscular stiffness and pain are typically nonadjustable; however, when such a feature is provided, such devices often require assistance of another person (e.g., a medical professional). FIG. 2 depicts a side view of the adjustable physical therapy device 100, in accordance with yet still other embodiments. The adjustable physical therapy device 100 includes a massaging frame 101. The massaging frame 101 includes vertical support arms 105 and horizontal support arms 110, which are each preferably C-lipped channel beams, structural channel beams, and/or parallel flange channel beams. The vertical support arms 105 are positioned parallel to each other.

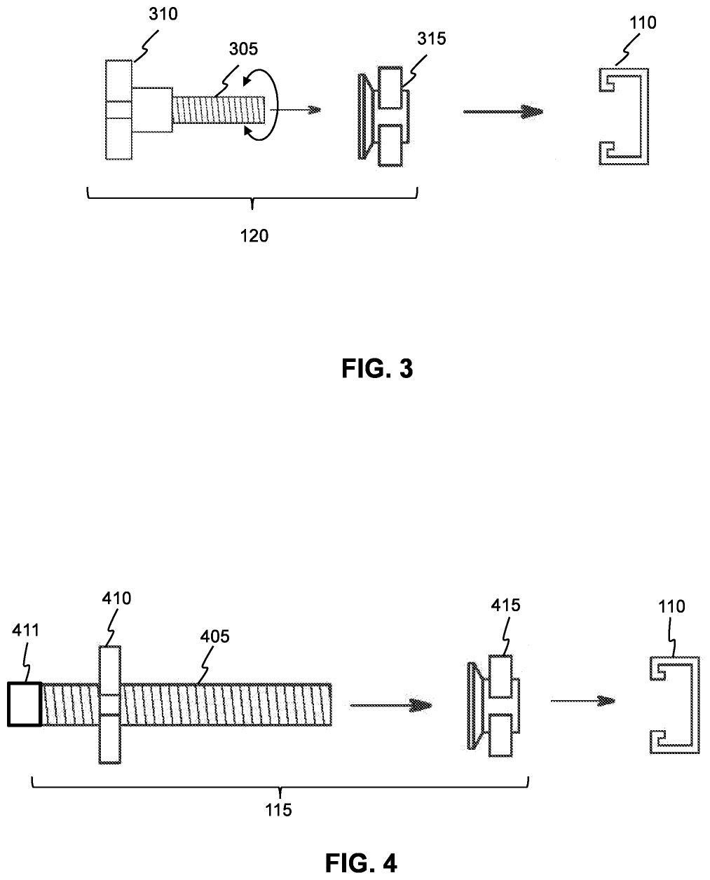

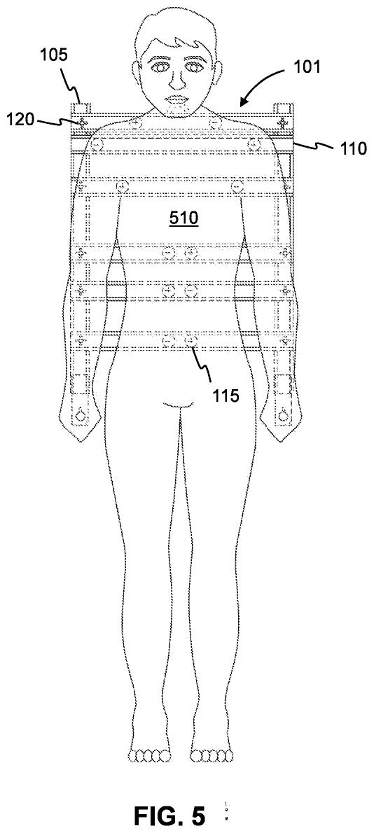

Similarly, the horizontal support arms 110 are positioned parallel to each other and slidably positioned on (e.g., coupled to) the vertical support arms 105 via affixing fasteners 120. The adjustable physical therapy device 100 include massaging points 115 are slidable positioned (i.e., they slide laterally) on the horizontal support arms 110. FIG. 3 depicts an exploded side view of the affixing fastener 120, in accordance with certain embodiments. The affixing fastener 120 preferably includes an end knob 310 affixed to a lug 305. The lug 305 screws into a channel nut 315 (i.e., by turning the end knob 310) that slidably couples the horizontal support arms 110 to the vertical support arms 105.

FIG. 4 depicts an exploded side view of a massaging point 115, in accordance with other embodiments. The massaging points 115 are each slidably coupled to and protrude from one of the horizontal support arms 210 in a manner to press against a user 510 when the user 510 is positioned against the massaging frame 101. Even more, in addition to upper extremities, the massaging frame 101 can be positioned to press against the user's 610 lower extremities. The massaging point 115 includes a knob 410 affixed to a lug 405 that allows the lug 405 to screw into a channel nut 415 that is slidably positioned within the horizontal beam 110.

The lug 405 includes an active end 411 protruding therefrom and positioned opposite the channel nut 415. For example, the active end 411 can be structurally oblong, oval, or polygonal. Alternatively, the massaging point 215 can include a compression spring inside a cylinder to allow it to compress when pressed against (e.g., similar to a shock absorber). In certain embodiments, the active end 411 is electrified and configured to provide pulsed electric current stimulation to the user 610. Electrical stimulation is a type of physical therapy modality or treatment used to accomplish various tasks in physical therapy. The idea is that applying an electrical current helps to strengthen muscles, block pain signals, and improve blood circulation.

In other embodiments, the active end 411 includes a magnet to provide magnetic field stimulation to the user 610. Magnetotherapy provides non-invasive, safe and easy to apply methods to directly treat the site of injury, the source of pain and inflammation as well as other types of dysfunctions. The application of permanent magnets for treating specific medical problems such as arthritis, chronic pain syndromes, is known in the art but is typically not included in mechanical PT rehabilitation devices such as disclosed herein. To be sure, the adjustable physical therapy device 100 can be configured to simultaneously provide electromagnetic field therapy as well as magnetic therapy by incorporating both types of the massaging points 215.

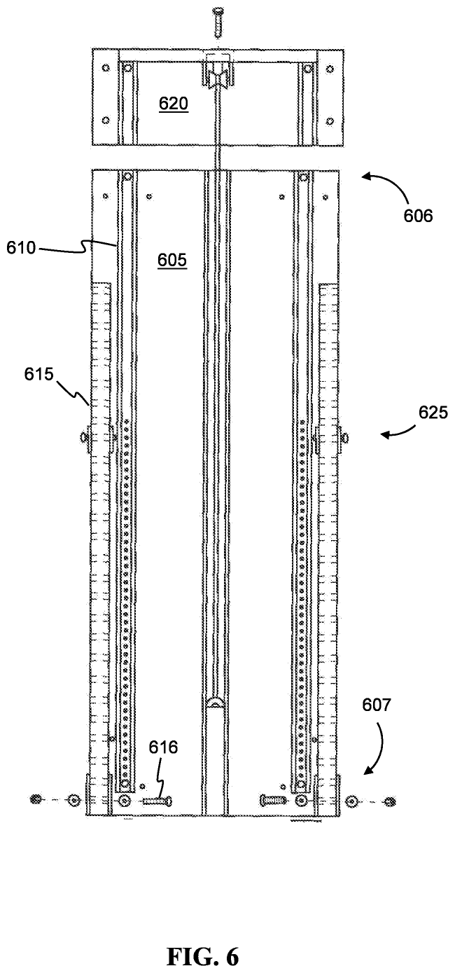

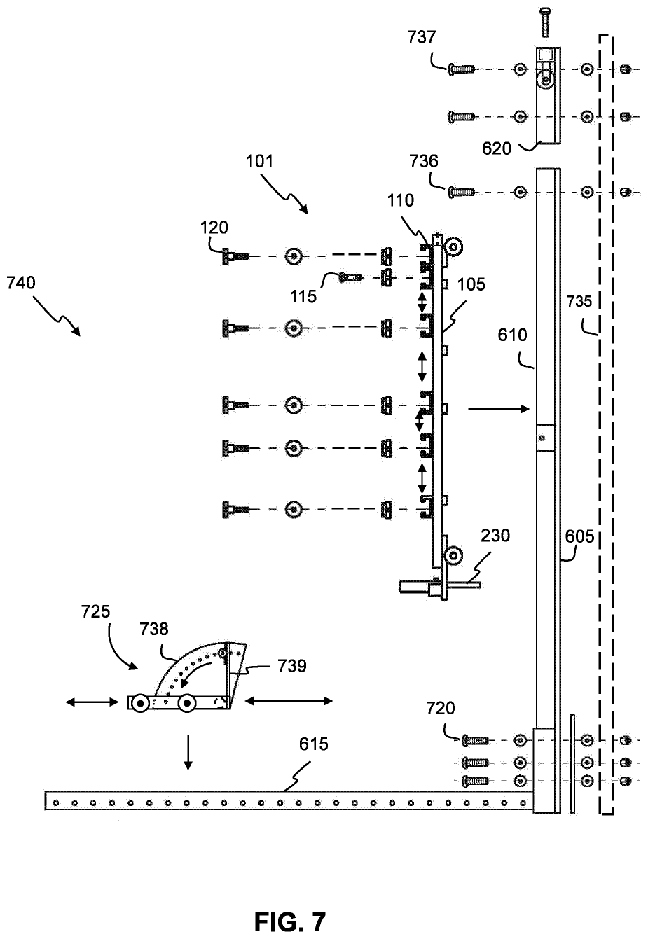

FIG. 6 depicts a front view of a support structure, generally 605, in a folded state 625, in accordance with yet still other embodiments. The support structure 605 can transition to a unfolded state 740, as depicted in FIG. 7. The adjustable physical therapy device 100 can further include the support structure 605. Although the support structure 605 is depicted in a vertical orientation, it can also be horizontally or angularly oriented. A pair of parallel tracks 610 are affixed to the support panel 605 (e.g., via fasteners 720 and 736). The support panel 605 can be configured to be affixed to a vertical structure 735 (e.g., a wall, a door, and/or a support frame). As depicted in FIG. 7, the support panel 605 includes a top 606 and a bottom 607.

The support panel 605 can include secondary support beams 615 that are each rotatably affixed proximate to the bottom 607 and one of the parallel tracks 610 (e.g., via fasteners 616 and/or 607). In the folded state 625, the secondary support beams 615 are oriented parallel (i.e., rotated towards) and positioned proximate to the parallel tracks 610. In the unfolded state 740, the secondary support beams 615 are oriented orthogonal to and rotated away from the parallel tracks 610 and support panel 605. In other words, in the unfolded state 740, the secondary support beams 615 are rotated in a manner to be non-parallelly oriented with the support panel 605. The secondary support beams 615 can be hollow structural sections (e.g., square or rectangle).

In the unfolded state 740, the secondary support beams 615 are configured to selectively receive a footrest 725 anywhere along its length. The footrest 725 selectively couples to the secondary support beams 615 (e.g., via appendages that selectively extend from the secondary support beam 615 to engage orifices positioned in the secondary support beams 615). In some embodiments, the footrest 725 includes a panel 739 positioned orthogonal to and between parallel supports 738 in a manner to orient itself selectively and angularly to the parallel supports 738. In other words, the panel 739 is selectably and rotatably affixed to parallel supports 738. In the unfolded state 740, the user 610 can position their feet on and apply pressure to the footrest 725 (specifically the panel 739) to press their body thereby further against the massaging frame 101.

In certain embodiments, the massaging frame 101 slidably traverses the parallel tracks 610 via wheels 135, which are rotatably coupled to the vertical support arms 105 opposite the horizontal support arms 110. Here, adjustable handles 230 demountably affix the position of the massaging frame 101 along the parallel tracks 610 by selectably engaging the parallel tracks 610. Alternatively, adjustable handles 230 can be replaced by a hinge device that selectably locks into (i.e., engages) the parallel tracks 610. The massaging points 215 protrude from the massaging frame 101 opposite the support panel 605.

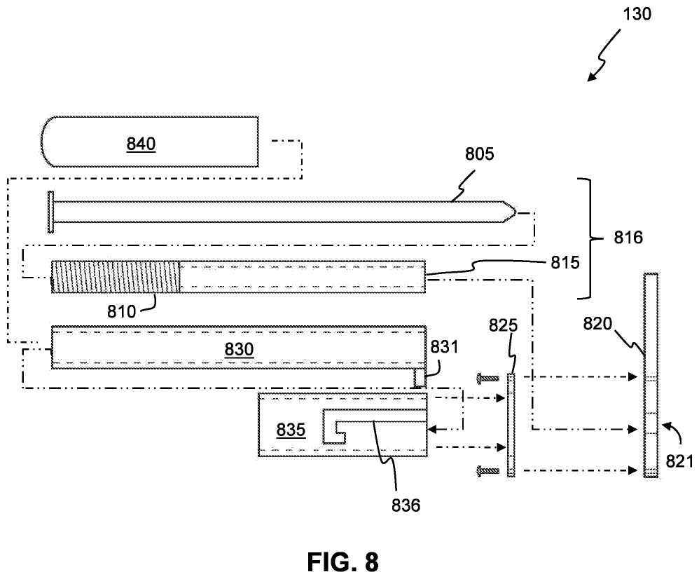

FIG. 8 depicts an exploded view of the adjustable handle 130, in accordance with yet still other embodiments. The adjustable handle 130 is affixed proximate to the bottom of the massaging frame 101 (or other position along the massaging frame 101) and configured to selectably engage orifices positioned in the parallel tracks 610 to thereby allow the massaging frame 101 to be slidably coupled to the parallel tracks 610. In other words, the adjustable handles 130 allow the massaging frame 101 to be positioned at any point along the parallel tracks 610 (e.g., to accommodate differing heights of the user 510 and/or address different pressure points along the user's 510 back).

The adjustable handle 130 includes a rod 805 positioned within spring tube 815, which has a spring 810 affixed thereto that engages the rod 805 to thereby form a spring-loaded rod 816. The spring 810 may also be affixed to rod 805. The spring-loaded rod 816 is affixed to a support plate 820 in a manner that the spring 810 is positioned opposite the support plate 820 and the rod 805 is allowed to selectably traverse orifice 821 of the support plate 820. A primary locking tube 830 is positioned within and rotatably coupled to a secondary locking tube 835, which is affixed to a washer 825. The primary locking tube 830 includes a flange 830 that laterally extends from its end. The secondary locking tube 835 includes a locking channel 835 that longitudinally extends from its end and forms a hooked channel.

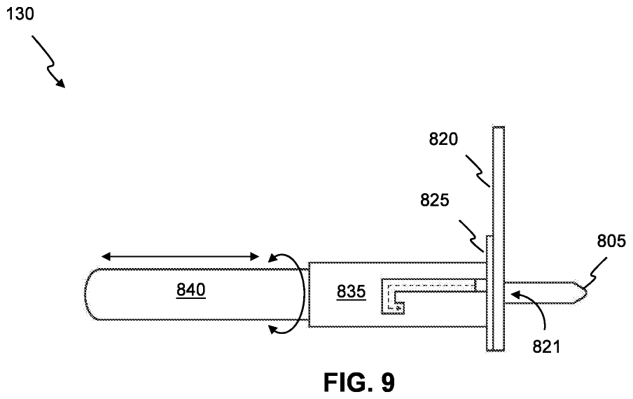

The locking channel 835 can be a cut-through structure or an internal structural depression or etching. The flange 830 is configured to traverse the locking channel 835 in a manner to selectably be positioned at either end of the hooked channel. The spring-loaded rod 816 is positioned the primary locking tube and the washer is subsequently affixed to the support plate 820. An outer sheath 840 is affixed to the primary locking tube 830 to allow the user 610 to selectably rotate and position the flange 831 at either end of the locking channel 835 and thereby selectably cause the working end of the rod 805 to traverse the orifice 821, as depicted in FIG. 9.

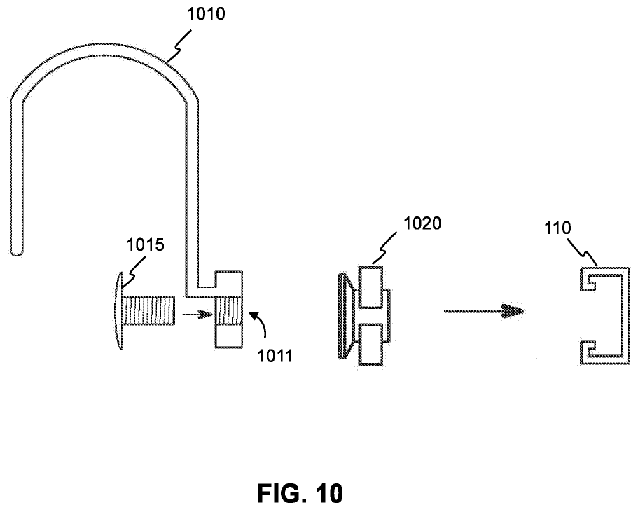

In certain embodiments, the adjustable physical therapy device 100 includes a pully system 620 positioned proximate to the top 606 that is functionally coupled to the massaging frame 101 to allow the user 510 to perform weighted squats (e.g., using a shoulder attachment 1010 that is attached to the massaging frame 101). FIG. 10 depicts a side view of the shoulder attachment 710, in accordance with certain embodiments. In embodiments that incorporate the pully system 620, the massaging frame 101 can include the shoulder attachments 1010 slidably coupled thereto that allow the user 510 to perform squatting exercises (e.g., to strengthen their back). The shoulder attachment 1010 preferably includes an orifice 1011 (e.g., a threaded channel). A screw 1015 is threaded through the orifice 1011 and screws into channel nut 1020, which is slidably positioned in the horizontal support arm 110 to thereby allow the shoulder attachments 1010 to be manually adjusted to the user's 510 shoulders. In other words, the channel nut 1020 laterally slides within the horizontal support arm 110.

Based on the foregoing, various embodiments of an adjustable physical therapy device have been disclosed in accordance with the instant disclosure. However, numerous modifications and substitutions can be made without deviating from the scope of the instant disclosure. Therefore, the instant disclosure has been disclosed by way of example and not limitation.

What is claimed is:

1. An adjustable physical therapy device, comprising:
a massaging frame;
massaging points;
wherein
the massaging frame comprises:
vertical support arms;
horizontal support arms;
the vertical support arms are positioned parallel to each other;
the horizontal support arms are slidably coupled to the vertical support arms; and
the massaging points are each slidably coupled to and protrude from one of the horizontal support arms in a manner to press against a user when the user is positioned against the massaging frame.

2. The adjustable physical therapy device of claim 1, wherein
one or more of the massaging points comprises a magnet positioned on an end of the massaging point.

3. The adjustable physical therapy device of claim 1, wherein
one or more of the massaging points comprises an electrified end configured to provide pulsed electromagnetic field therapy.

4. The adjustable physical therapy device of claim 1, wherein
the vertical support arms each comprise a wheel;
the wheel is rotatably coupled to the vertical support arm opposite the horizontal support arms.

5. The adjustable physical therapy device of claim 1, further comprising:
a support structure;
wherein
the support structure is vertically or horizontally oriented;
the massaging frame is coupled to the support structure.

6. The adjustable physical therapy device of claim 1, further comprising:
a support structure;
a pair of parallel tracks:
wherein
the support structure is vertically or horizontally oriented;
the parallel tracks are affixed to the support structure;
the massaging frame slidably traverses the parallel tracks.

7. The adjustable physical therapy device of claim 6, wherein
the support structure is configured to be affixed to a vertical structure; and
the vertical structure comprises a wall, a door, and/or a support frame.

8. The adjustable physical therapy device of claim 6, further comprising
the support structure comprises a pully system; and
the pully system is functionally coupled to the massage frame.

9. The adjustable physical therapy device of claim 6, further comprising:
secondary support beams;
wherein
each secondary support beam is rotatably affixed to a bottom of the support structure proximate to one of the parallel tracks.

10. The adjustable physical therapy device of claim 9, further comprising:
a folded state;
an unfolded state;
wherein
in the folded state, the secondary support beams are oriented parallel and positioned proximate to the parallel tracks; and
in the unfolded state, the secondary support beams are oriented orthogonal to and are rotated away from the parallel tracks.

11. The adjustable physical therapy device of claim 10, further comprising:
a footrest selectively coupled to the secondary support beams;
wherein the footrest comprising:
a panel;
parallel supports;
the panel is selectably and rotatably affixed to parallel supports.

12. The adjustable physical therapy device of claim 11, wherein
the massaging frame comprises an adjustable handle that allows the massaging frame to be selectably positioned along the parallel tracks;
the adjustable handle comprises:
a spring-loaded rod that selectably engages a vertical beam.

13. An adjustable physical therapy device, comprising:
a massaging frame;
massaging points;
wherein
the massaging frame comprises:
vertical support arms;
horizontal support arms;
the vertical support arms are positioned parallel to each other;
the horizontal support arms are slidably coupled to the vertical support arms;
the massaging points are each slidably coupled to and protrude from one of the horizontal support arms in a manner to press against a user when the user is positioned against the massaging frame;
one or more of the massaging points comprises a magnet positioned on an end of the massaging point; and
one or more of the massaging points comprises an electrified end configured to provide pulsed electromagnetic field therapy.

14. The adjustable physical therapy device of claim 13, wherein
the vertical support arms each comprise a wheel;
the wheel is rotatably coupled to the vertical support arm opposite the horizontal support arms.

15. The adjustable physical therapy device of claim 13, further comprising:
a support structure;
wherein
the support structure is vertically or horizontally oriented;
the massaging frame is coupled to the support structure.
